(19) United States
(12) Patent Application Publication
(10) Pub. No.: US 2022/0198468 A1
(43) Pub. Date: Jun. 23, 2022

(54) SPEECH INFORMATION COMMUNICATION MANAGEMENT METHOD AND APPARATUS, STORAGE MEDIUM, AND DEVICE

(71) Applicant: TENCENT TECHNOLOGY (SHENZHEN) COMPANY LIMITED, Shenzhen (CN)

(72) Inventor: Chunyong CHEN, Shenzhen (CN)

(73) Assignee: TENCENT TECHNOLOGY (SHENZHEN) COMPANY LIMITED, Shenzhen (CN)

(21) Appl. No.: 17/693,971

(22) Filed: Mar. 14, 2022

Related U.S. Application Data
(63) Continuation of application No. PCT/CN2020/127810, filed on Nov. 10, 2020.

(30) Foreign Application Priority Data
Feb. 18, 2020 (CN) 202010100493.1

(51) Int. Cl. G06Q 30/00; G10L 17/14; G10L 17/22; G10L 17/02; G06F 40/30; G10L 17/04; H04L 67/12

(52) U.S. Cl. CPC G06Q 30/018; G10L 17/14; G10L 17/22; H04L 67/12; G06F 40/30; G10L 17/04; G10L 17/02

(57) ABSTRACT

A speech information communication management method and apparatus, a storage medium, and a device, the method includes obtaining speech information published by a user on a first network platform in a blockchain network; performing violation recognition on the speech information to obtain a violation recognition result; in a case that the violation recognition result meets a preset violation condition, generating violation credit record data of the user according to the violation recognition result, platform identifier information of the first network platform, and user identifier information of the user; broadcasting the violation credit record data of the user to a second network platform in the blockchain network; and after the blockchain network reaches a consensus on the violation credit record data of the user, storing the violation credit record data of the user into a blockchain corresponding to the user.

### CROSS-REFERENCE TO RELATED APPLICATION(S)

This application is a continuation application of International Application No. PCT/CN2020/127810, filed on Nov. 10, 2020, which claims priority to Chinese Patent Application No. 202010100493.1, filed with the China National Intellectual Property Administration on Feb. 18, 2020, the disclosures of which are incorporated by reference in their entireties.

### FIELD

The disclosure relates to the field of blockchain technologies, and specifically, to a speech information communication management method and apparatus, and a storage medium and device.

### BACKGROUND

In recent years, voice-based social contact has become a social contact manner popular among present young people. Voice-based social contact refers to using voice as a major communication manner to implement functions such as friend making, information exchange and interaction, and communication and sharing. In terms of user experience, voice-based social contact is more lively and interesting than text-based social contact. Voice-based social contact has higher privacy, is easier to learn, and can more express true emotions than picture-based and video-based social contact.

However, current supervision on the voice-based social contact mainly depends on a manual review via network platforms, which is inefficient and inaccurate. In addition, data of different network platforms is not interconnected, and violation behavior of a user on a single network platform generally does not affect speech information communication of the user on other network platforms. As a result, speech information communication behavior of users cannot be effectively regulated.

### SUMMARY

Embodiments of the disclosure provide a speech information communication management method and apparatus, a storage medium, and a device.

A speech information communication management method may be provided, performed by a computer device, including: obtaining speech information published by a user on a first network platform; performing violation recognition on the speech information to obtain a violation recognition result; in a case that the violation recognition result meets a preset violation condition, generating violation credit record data of the user according to the violation recognition result, platform identifier information of the first network platform, and user identifier information of the user; broadcasting the violation credit record data of the user to a second network platform in the blockchain network; and after the blockchain network reaches a consensus on the violation credit record data of the user, storing the violation credit record data of the user into a blockchain corresponding to the user.

In an embodiment, the method may further include: receiving a user violation credit obtaining request transmitted by a terminal, the user violation credit obtaining request carrying a user identifier; determining the blockchain corresponding to the user according to the user identifier; obtaining a block in the blockchain, and determining the violation credit record data of the user from the block; and returning the violation credit record data of the user to the terminal.

In an embodiment, the method may further include: obtaining target information of the user from the blockchain corresponding to the user according to the user identifier information and the violation credit record data to be modified; in a case that the target information meets a preset parameter modification condition, obtaining violation credit metric information according to the met parameter modification condition; generating target violation credit record data according to the violation credit metric information, the user identifier information, the target information, and the platform identifier information of the first network platform; broadcasting the target violation credit record data to the second network platform in the blockchain network; and after the blockchain network reaches a consensus based on the target violation credit record data, storing the target violation credit record data into the blockchain corresponding to the user.

A speech information communication management apparatus may be provided, including: at least one memory configured to store computer program code; and at least one processor configured to read the computer program code and operated as instructed by the computer program code, the computer program code comprising: obtaining code configured to cause the at least one processor to obtain speech information published by a user on a first network platform in a blockchain network; recognition code configured to cause the at least one processor to perform violation recognition on the speech information to obtain a violation recognition result; generation code configured to cause the at least one processor to: in a case that the violation recognition result meets a preset violation condition, generate violation credit record data of the user according to the violation recognition result, platform identifier information of the first network platform, and user identifier information of the user; broadcast code configured to cause the at least one processor to broadcast the violation credit record data of the user to a second network platform in the blockchain network; and storage code configured to cause the at least one processor to: after the blockchain network reaches a consensus on the violation credit record data of the user, store the violation credit record data of the user into a blockchain corresponding to the user.

A computer-readable storage medium may be provided, storing a computer program, the computer program, when run on a computer, causing the computer to implement the speech information communication management method according to any one of the embodiments in the disclosure.

A speech information communication device may be provided, including a memory and a processor, the memory storing a computer program, and the processor, when executing the computer program, implementing the speech information communication management method according to any one of the embodiments in the disclosure.

A computer program product or a computer program may be provided, the computer program product or the computer program including computer instructions, the computer instructions being stored in a computer-readable storage medium. The computer instructions, when read from the computer-readable medium and executed by a processor of a first node, cause the processor to perform the operations of the speech information communication management method.

Details of one or more embodiments of the disclosure are provided in the accompanying drawings and descriptions below. Other features and advantages of the disclosure become obvious with reference to the specification, the accompanying drawings, and the claims.

### BRIEF DESCRIPTION OF THE DRAWINGS

To describe the technical solutions in the embodiments of the disclosure more clearly, the following briefly describes accompanying drawings required for describing the embodiments. The accompanying drawings in the following description show merely some embodiments of the disclosure, and a person skilled in the art may still derive other accompanying drawings from these accompanying drawings without creative efforts. In addition, one of ordinary skill would understand that aspects of example embodiments may be combined together or implemented alone.

FIG. 1A is a schematic scene diagram of a speech information communication management system according to an embodiment of the present disclosure.

FIG. 1B is a schematic structural diagram of a blockchain according to an embodiment of the present disclosure.

FIG. 1C is a schematic flowchart of block generation in a blockchain according to an embodiment of the present disclosure.

FIG. 2A is a first schematic flowchart of a speech information communication management method according to an embodiment of the present disclosure.

FIG. 2B is a second schematic flowchart of a speech information communication management method according to an embodiment of the present disclosure.

FIG. 2C is a third schematic flowchart of a speech information communication management method according to an embodiment of the present disclosure.

FIG. 3A is a first schematic structural diagram of a speech information communication management apparatus according to an embodiment of the present disclosure.

FIG. 3B is a second schematic structural diagram of a speech information communication management apparatus according to an embodiment of the present disclosure.

FIG. 3C is a third schematic structural diagram of a speech information communication management apparatus according to an embodiment of the present disclosure.

FIG. 4 is a schematic structural diagram of a speech information communication device according to an embodiment of the present disclosure.

FIG. 5A is a schematic diagram of a speech live streaming interface according to an embodiment of the present disclosure.

FIG. 5B is a schematic diagram of a speech live streaming interface when violation is recognized according to an embodiment of the present disclosure.

FIG. 5C is a schematic diagram of a speech live streaming interface when recognizing that a violation credit score (or referred to as credit score) is lower than a preset value according to an embodiment of the present disclosure.

FIG. 6 is a schematic flowchart of speech information communication management according to an embodiment of the present disclosure.

FIG. 7 is a schematic flowchart of speech recognition according to an embodiment of the present disclosure.

### DESCRIPTION OF EMBODIMENTS

The technical solutions in embodiments of the disclosure are clearly and completely described in the following with reference to the accompanying drawings in the embodiments of the disclosure. The described embodiments are merely some rather than all of the embodiments of the disclosure. All other embodiments obtained by a person skilled in the art based on the embodiments of the disclosure without creative efforts shall fall within the protection scope of the disclosure.

Before the embodiments of the disclosure are explained and described in detail, some terms involved in the embodiments of the disclosure are explained and described first.

Speech information communication: the speech information communication in the disclosure refers to using speech information as a major communication manner to implement friend making, information exchange and interaction, and communication and sharing on a network platform. Forms such as speech live streaming and speech calling are mainly included, and a form of speech message may be also included.

Blockchain: the blockchain technology is derived from the Bitcoin technology, is an underlying technology of Bitcoin, and is a decentralized distributed ledger database. The blockchain is a string of data blocks (that is, blocks) generated through association by using a cryptographic algorithm, and each data block includes information that is effectively confirmed by a plurality of blockchain network transactions. Based on this, cheating cannot be performed by tampering with data on the blocks, so that it can be ensured that data on any block is open and the data security is ensured. To clearly describe a blockchain system and a chain formed by blocks in the following description, a blockchain system including a plurality of nodes may be referred to as a blockchain network, and a chain formed by data stored in the blockchain is referred to as a blockchain.

The blockchain network may be classified into a public blockchain, a private blockchain, a consortium blockchain. The consortium blockchain is between the public blockchain and the private blockchain. Several organizations work together to maintain one blockchain network, and use of the blockchain network needs to be managed with permissions, so that related information is protected, and the organizations are typically, for example, financial organizations. In conclusion, the blockchain network is a distributed database system in which nodes participate, or may be referred to as a distributed public ledger based on a peer-to-peer (P2P) network. Features of the blockchain are unchangeable and unforgeable, and the blockchain network may also be understood as a ledger system.

Node of a blockchain network: a device participating in construction of a blockchain network, for example, a computer device of a content provider participating in the construction of the blockchain network. The computer device may be a single computer device such as a single server of one content provider, or may be a computer device cluster such as a server cluster of one content provider. Nodes of the blockchain network may be an execution entity of information processing, and services such as transactions may be implemented through interactions among the nodes. The node stores a related block. For example, the block may include violation credit record data (or referred to as credit record data) of a user. In this embodiment, a server of a network platform can serve as a node of the blockchain network.

The following describes a speech information communication management method and apparatus, and a storage medium according to the embodiments of the disclosure.

The embodiments of the disclosure provide a speech information communication management method and apparatus, a storage medium and a device. The speech information communication management method may be performed by a computer device, and the computer device may be a speech information communication device managing speech information communication, which specifically may be a server or a device such as a terminal. The terminal may include devices such as a mobile phone, a tablet computer, a notebook computer, a personal computer (PC), and an in-vehicle terminal. The server may be a single server or may be a server cluster including a plurality of servers. When the computer device is a single server, the computer device may be integrated in a first node of a blockchain, and the first node may be any node in the blockchain.

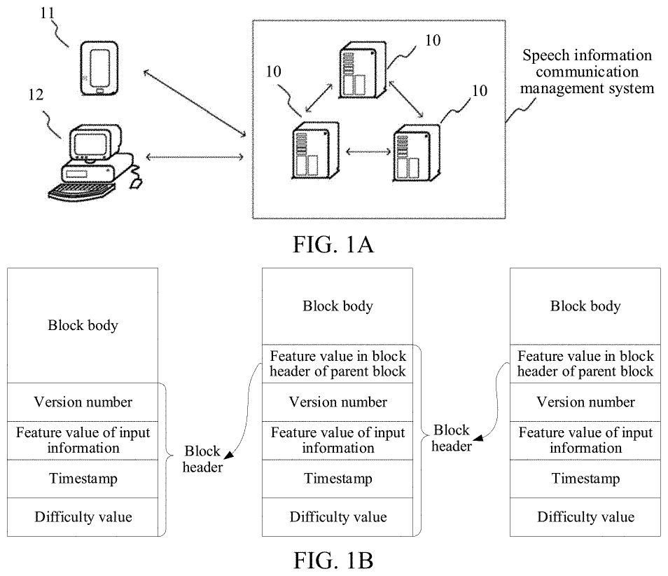

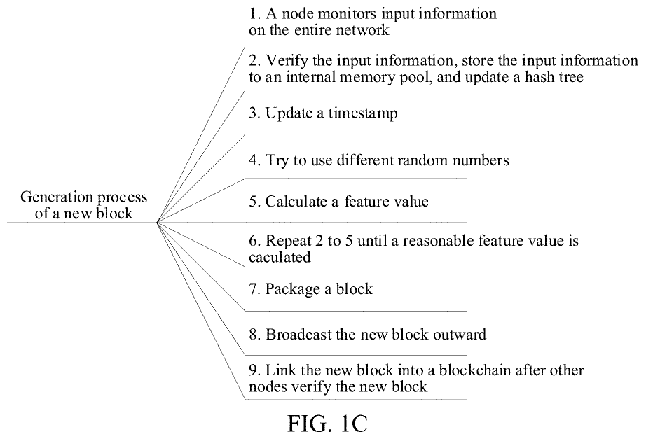

For example, referring to FIG. 1A, an embodiment of the disclosure provides a speech information communication management system, and the system can implement services such as speech information communication management. The system may include nodes and terminals such as a mobile phone and a computer of a plurality of blockchains, where the plurality of nodes are connected through a network, and the nodes and the terminals are also connected through a network.

In this embodiment of the disclosure, speech information published by a user on a first network platform in a blockchain network may be obtained; violation recognition is performed on the speech information to obtain a violation recognition result; in a case that the violation recognition result meets a preset violation condition, violation credit record data of the user is generated according to the violation recognition result, platform identifier information of the first network platform, and user identifier information of the user; the violation credit record data of the user is broadcast to a second network platform in the blockchain network; and after the blockchain network reaches a consensus on the violation credit record data of the user, the violation credit record data of the user is stored into a blockchain corresponding to the user. By storing the violation credit record data of the user into the blockchain, violation credit data of the user can be shared to all network platforms in the blockchain. Therefore, speech information communication behavior of the user on all the network platforms is effectively supervised.

During actual application, the blockchain network further provides an information query function, for ease of querying the violation credit record data of the user. Specifically, a node of the blockchain network may receive a violation credit parameter obtaining request transmitted by a server of a network platform. The violation credit parameter obtaining request includes a user identifier for requesting the violation credit record data corresponding to the user, and the node of the blockchain network may then search for the violation credit record data corresponding to the user from the blockchain according to the user identifier, and transmit violation credit record data corresponding to a target user to a server of the second network platform.

Detailed descriptions are separately provided below. The sequence of the following embodiments is not intended to limit preference orders of the embodiments.

I. Construction of a Blockchain Network:

A structure of the blockchain may include a blockchain underlying platform, a platform product service layer, and an application service layer.

The blockchain underlying platform may include processing modules such as a user management module, a basic service module, a smart contract module, and an operation supervision module. The user management module is responsible for identity information management of all blockchain participants, including maintaining public-private key generation (account management), key management, maintaining a correspondence between the real identity of a user and a blockchain address (permission management), and the like, supervising and auditing transaction conditions of some real identities with authorization, and providing rule configuration of risk control (risk control auditing). The basic service module is deployed on all blockchain node devices and configured to verify the validity of a service request, and after a consensus is reached on a valid request, record the valid request in storage. For a new service request, the basic service module first parses interface adaptation and performs authentication processing (interface adaptation), then encrypts service information by using a consensus algorithm (consensus management), transmits the complete and consistent service information after encryption to a shared ledger (network communication), and performs recording and storing. The smart contract module is responsible for contract registration and publication, contract triggering, and contract execution. A developer may define contract logic by using a programming language, and release the contract logic onto a blockchain (contract registration). According to the logic of contract items, a key or another event is invoked to trigger execution, to complete the contract logic. The function of upgrading or canceling a contract is further provided. The operation supervision module is mainly responsible for deployment, configuration modification, contract setting, and cloud adaptation during product releasing and visualized output of a real-time status during product operation, for example, alarming, monitoring network conditions, and monitoring a health status of a node device.

The platform product service layer provides basic capabilities and an implementation framework of a typical application. Based on these basic capabilities, a developer may superpose characteristics of services and complete blockchain implementation of service logic. The application service layer provides a blockchain solution-based application service for use by a service participant.

II. After the Blockchain Network is Constructed, the Blockchain Network May be Used to Perform Speech Information Communication Management:

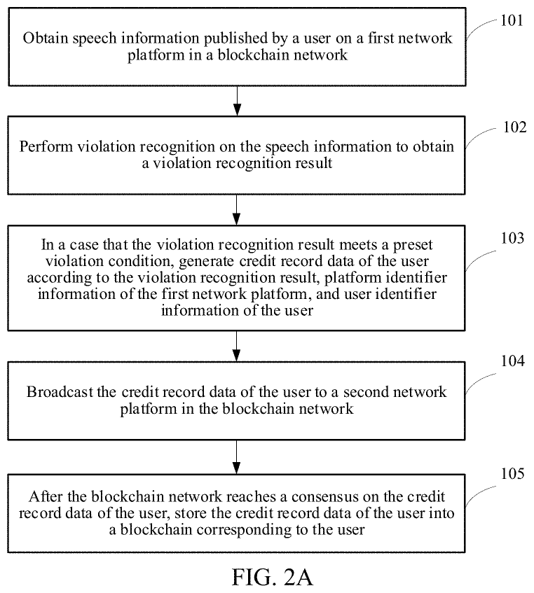

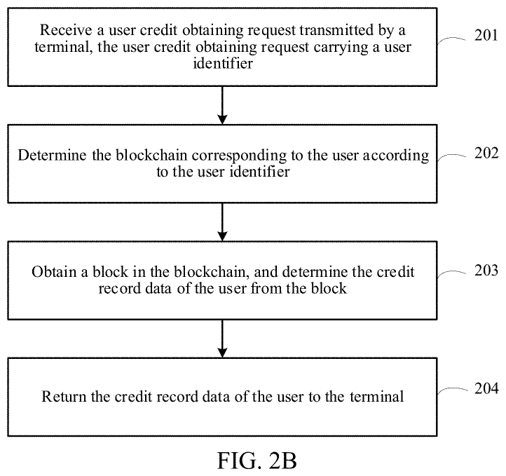

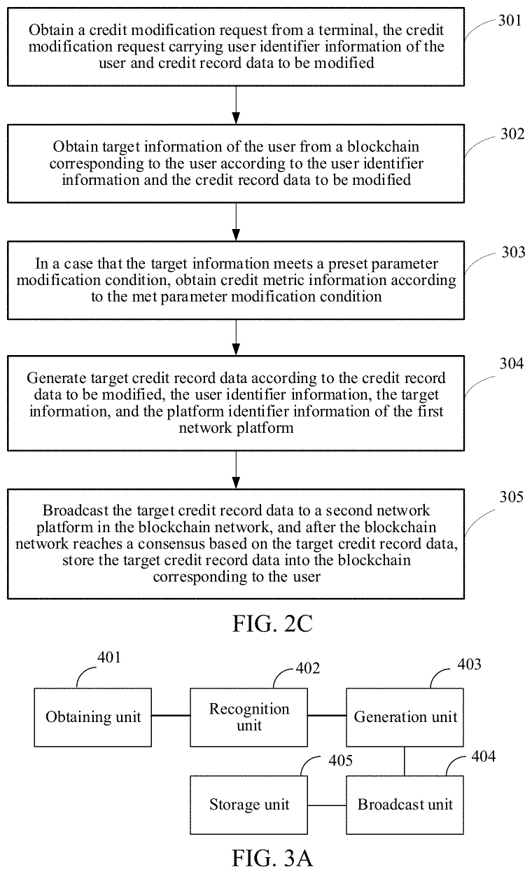

In an embodiment, referring to FIG. 2A, a description is made by using a process of writing violation credit record data into a blockchain as an example. This process is described in terms of a speech information communication management apparatus, and the speech information communication management apparatus specifically may be integrated in a server of the first network platform.

101: Obtaining speech information published by a user on a first network platform in a blockchain network.

Speech information communication in this embodiment of the disclosure is mainly performed in the form of a data stream, speech information transmitted by a publisher is obtained and broadcast in real time, and forms such as speech live streaming and speech calling may be included.

The speech communication method such as speech live streaming or speech calling in the embodiments of the disclosure is a communication manner that can publish and receive information in real time. The speech live streaming refers to that an anchor publishes speech information in a speech live streaming room, and audience receives the speech information published by the anchor through the speech live streaming room. The speech live streaming room may be understood as a network address interface configured to publish and receive speech information, and the anchor is a user publishing the speech information in the live streaming process. The anchor may also perform speech interaction with another anchor in a manner of performing a video call. During the video call, a speech interaction process of the two parties (anchors) performing the video call may be published in live streaming rooms of the two parties.

In a live streaming process, the anchor can import audio and video into a director client in a terminal by using an independent signal acquisition device that is set up on site, and upload the audio and video to a server of a network platform by using a network, to publish the audio and video to a network address interface for the audience to watch by using a playback client.

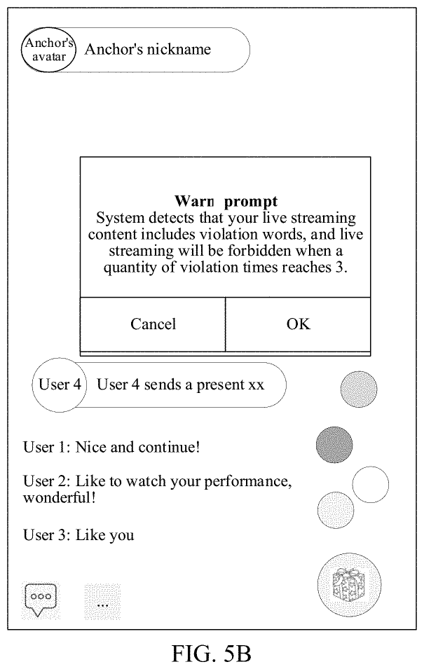

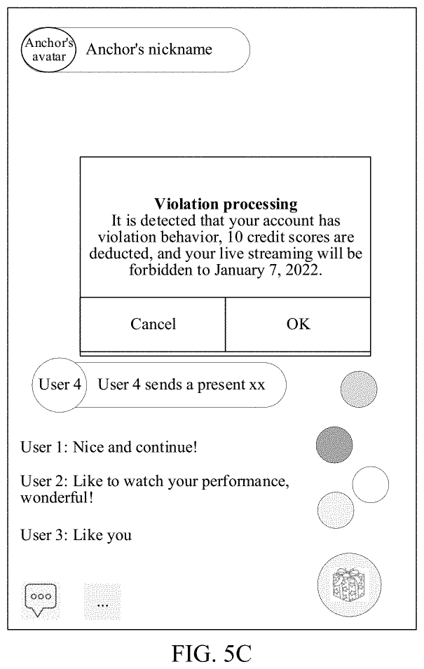

The live streaming room of the anchor may be open to all users in the network platform, and may be open to specific users according to setting of the anchor. The speech live streaming room is shown in FIG. 5A, the speech live streaming room does not have a video picture, and when the anchor speaks, sound waves appear around an avatar of the anchor.

The speech communication is a communication manner that is not open to users and in which a plurality of users mutually publish speech information.

The live streaming and the speech communication relate to a streaming media technology. The streaming media technology refers to a technology that transmits, after compressing a series of media data, the media data in the form of a data stream in a network segment by segment, to transmit a media data stream in the network in real time for playing.

The user transmits speech information to the network platform in the form of a media data stream. In an embodiment, the media data stream can be transmitted by using a speech information compressed packet as a unit, and the speech information is obtained by decoding the obtained media data stream by a server.

The first network platform may be any network platform participating in the blockchain network, and the second network platform may also be a network platform other than the first network platform in the blockchain network and may be represented as any network platform in the blockchain network. The network platform is a platform implementing speech information communication through a network.

102: Performing recognition on the speech information by using a preset speech recognition algorithm to obtain text information corresponding to the speech information.

Performing recognition on the speech information relates to an automatic speech recognition (ASR) technology of artificial intelligence. The ASR technology converts vocabulary content in the speech information into computer-readable input, including keystrokes, binary codes, and character streams. The ASR technology is one key technology of speech technologies. To make a computer capable of listening, seeing, speaking, and feeling is the future development direction of human-computer interaction, and speech has become one of the most promising human-computer interaction methods in the future.

In an embodiment, referring to FIG. 7, the performing recognition on the speech information by using a preset speech recognition algorithm to obtain text information corresponding to the speech information may specifically include the following operations:

dividing the speech information to obtain an audio frame sequence corresponding to the speech information;

performing feature extraction on audio frames in the audio frame sequence, to obtain audio feature information corresponding to the speech information;

obtaining phonemes corresponding to the audio feature information according to a preset acoustic model;

performing comparison and matching on the phonemes and a preset dictionary according to a preset language model, to obtain text words corresponding to the phonemes; and

extracting semantic association information among the text words, and combining the text words according to the association information to obtain the text information.

In an embodiment, preprocessing includes emphasis, framing, and windowing. To prevent a change between two adjacent frames from being excessively large, emphasis may be performed on the speech information, and framing is then performed on the speech information by using a voice activity detection (VAD) technology, to divide the speech information uploaded by the anchor into a plurality of segments, where each segment is referred to as an audio frame, and frames generally overlap with each other. Mute portions at head and tail ends are removed to reduce interference caused to subsequent operations. For example, a length of each audio frame is 25 milliseconds, and every two audio frames have a repeating part whose length is 15 milliseconds. After framing is performed, speech is divided into a plurality of segments, and feature extraction is performed on a waveform of each frame according to physiological characteristics of human ears, to obtain a multi-dimensional vector.

In an embodiment, audio feature information may be represented as a Mel-frequency cepstral coefficient (MFCC) vector, and the process of the performing feature extraction may include the following operations: substituting the audio frames into a Hamming window function to obtain a short-term analysis window corresponding to each audio frame; Fourier transform is performed on each short-term analysis window to obtain a corresponding spectrum; and frequency inaudible to humans in the spectrum is filtered by using a Mel filter group to obtain a Mel spectrum, so that a linear natural spectrum is converted into a Mel spectrum reflecting human auditory characteristics. Cepstral analysis is performed on the Mel spectrum (logarithmizing and inverse transform are performed, actually, the inverse transform is generally implemented through discrete cosine transform, and the second coefficient to the thirteenth coefficient after the discrete cosine transform are used as Mel-frequency cepstral coefficients), to obtain Mel-frequency cepstral coefficients. 12 Mel-frequency cepstral coefficients of each frame are combined to obtain a cepstral vector of each audio frame. In an embodiment, an interframe dynamic change feature may be further calculated according to the Mel-frequency cepstral coefficient to form the cepstral vector with the Mel-frequency cepstral coefficient jointly. Cepstral vectors of all audio frames are audio feature information of the speech information.

A phoneme is the minimum phonetic unit obtained through division from a perspective of timbre. The preset dictionary is used for describing mapping between text words to speech phones. In addition to the dictionary, a machine learning algorithm may be further used to obtain some complex functions through learning to complete a mapping function. The mapping function is learned by training a neural network model, to obtain a text word stream according to a speech feature information stream.

In an embodiment, a hidden Markov model (HMM) may be used as an acoustic model. The HMM needs to be trained for use,

In another embodiment, a language model may be further trained based on a deep neural network, and the extracted features are inputted into the language model, to obtain the text information corresponding to the speech information.

103: Performing violation recognition on the text information according to a preset violation information set, to obtain a violation recognition result.

The network platform may preset a violation information set. The preset violation information set is a violation information base generated according to laws and regulations of national audio and video live streaming. In an example, the violation information base may include any one or more of the following content: (1) information related to pornography, gambling, and drugs; (2) rumors or other information disturbing social orders and destroying social stability; (3) information including false, harmful, threatening, privacy-infringing, slanderous, vulgar, fraud, or other morally disgusting content; (4) information about forged and fake products or products that are not authorized for sales; and (5) key feature words in the foregoing content.

The server of the network platform can perform violation recognition on the text information through keyword matching or natural language processing (semantic analysis). In an embodiment, in a case that the text information includes violation information, the text information is determined as violation, and statistics collection is performed on information matching the violation information in the text information, to obtain the violation recognition result. In a speech live streaming process, in a case that a quantity of times that key feature words of the violation information included in the text information that are recognized reaches a preset violation credit threshold, the text information is determined as violation, and statistics collection is then performed on the key feature words that are successfully matched in the text information. The violation recognition result is a conclusion including whether the text information is violation, and in a case that the conclusion is violation, the violation recognition result further includes the information obtained through statistics collection.

104: In a case that the violation recognition result meets a preset violation condition, generating violation credit record data of the user according to the violation recognition result, platform identifier information of the first network platform, and user identifier information of the user.

The violation credit record data of the user is data (such as violation credit metric information (or referred to as credit metric information)) used for representing a violation credit of the user at a current moment, and may further include information changing the violation credit of the user (for example, the violation recognition result).

In an embodiment, the in a case that the violation recognition result meets a preset violation condition, generating violation credit record data of the user according to the violation recognition result, platform identifier information of the first network platform, and user identifier information of the user specifically may include the following operations:

in a case that the violation recognition result meets the preset violation condition, generating a violation record according to a time, the platform identifier information of the first network platform, and the violation recognition result;

obtaining violation credit metric information of the user according to the violation recognition result; and

generating the violation credit record data of the user according to the violation record, the violation credit metric information, and the user identifier information.

The violation credit metric information is information used for measuring the violation credit of the user at the current moment, and may be represented as a violation credit parameter (state value) of the user or a violation credit parameter change value of the user.

In a case that the violation credit metric information is represented as a violation credit parameter (state value), a violation credit parameter of the user before the current moment needs to be obtained from the blockchain in advance, and the violation credit parameter of the user at the current moment is calculated according to the violation credit parameter before and a violation credit change value corresponding to the violation recognition result.

Different violation types have different change degrees to the violation credit. For example, the network platform may set that, in a case that a quantity of times of gambling keywords that are recognized reaches the preset violation credit threshold, the violation credit parameter is reduced by 2 units, and in a case that fraud information is recognized, the violation credit parameter is reduced by 4 units.

After obtaining the violation credit metric information of the user according to the violation recognition result, the server of the first network platform may further implement the following operations:

performing speech information publish permission recognition on the user according to a preset violation credit threshold and the violation credit metric information, to obtain a permission recognition result; and

stopping, in a case that the permission recognition result represents that the user does not have a speech information publish permission, receiving the speech information transmitted by the user.

In an embodiment, after the obtaining violation credit metric information of the user according to the violation recognition result, the method further includes the following operations:

generating a violation credit alarm message according to the violation record and the violation credit metric information; and

returning the violation credit alarm message to a terminal.

Referring to FIG. 5B, in a case that the server recognizes violation speech, corresponding prompt information is generated, and the prompt information is transmitted to the terminal for display.

Referring to FIG. 5C, after obtaining the violation credit metric information of the user according to the violation recognition result, the server continues to perform live streaming permission recognition according to the preset violation credit threshold and metric parameter information of the user, and in a case that the violation credit parameter of the user does not meet the preset violation credit threshold, the server stops receiving the speech information uploaded by the user and transmits prompt information to the terminal.

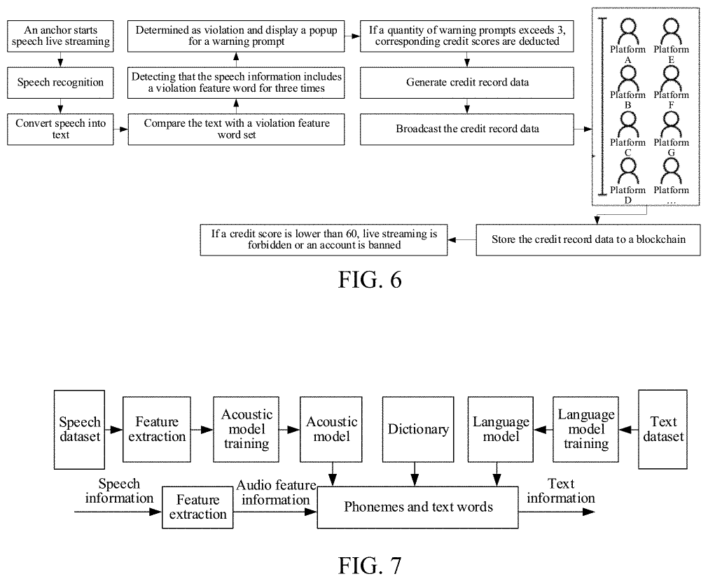

Referring to FIG. 6, in another embodiment, to make the displayed violation credit alarm information more real and believable, after the blockchain network reaches a consensus on the violation credit record data of the user, speech information publish permission recognition may be performed on the user according to the violation record and the violation credit metric information in the violation credit record data, to obtain a permission recognition result.

In an embodiment, the generating the violation credit record data of the user according to the violation record, the violation credit metric information, and the user identifier information specifically may include the following operations:

combining the violation credit metric information with the violation record to obtain first combination information;

combining the user identifier information with the registration identity information to obtain second combination information; and generating an association information pair according to the first combination information and the second combination information to obtain the violation credit record data of the user.

The violation record is also written into the blockchain as a part of the violation credit record data rather than merely writing the violation credit metric information into the blockchain, so that the reality and security of the violation credit record data can be improved. In addition, the violation record may be further used as evidence in a case that the user doubts the reality of the violation credit record data and performs violation credit appealing.

The association information pair is a combination manner of association information and specifically may be represented in a form of a key-value pair. The server may generate a key element in the key-value pair according to the user identifier information, generate a value element in the key-value pair according to the user identifier information and the violation credit record data, and associate the key element with the value element.

The user identifier information may be used for determining the blockchain corresponding to the violation credit record data.

In an embodiment, in a case that the violation credit record data is generated, registration identity information of the user in the first network platform may be further obtained according to the user identifier information of the user; the violation credit metric information is combined with the violation record to obtain first combination information, and the user identifier information is combined with the registration identity information to obtain second combination information; and an association information pair is generated according to the first combination information and the second combination information to obtain the violation credit record data of the user.

The registration identity information refers to information such as an identity card, a mail box, and a mobile phone used for verifying an identity in a case of registering an account on the network platform. Generally, the first network platform may not share the registration identity information of the user to other network platforms. In a case that the user has violation, the first network platform can upload the violation credit record data of the user to the blockchain, to share the violation credit record data to the second network platform in the blockchain network. In this way, in a case that the identity information of the user needs to be queries when an account is registered or speech information is published, after the user is forbidden from live streaming or the account thereof is banned on the first network platform, the user cannot use the same identity information to register an account and publish speech information on other network platforms. Therefore, speech live streaming behavior of the user can be more effectively supervised.

105: Broadcasting the violation credit record data of the user to a second network platform in the blockchain network.

The second network platform is a network platform other than the first network platform in the blockchain network.

In an embodiment, before storing the violation credit record data of the user into the blockchain, the second network platform further needs to verify the violation credit record data, to ensure that the data is not tampered with in a transmission process.

In an embodiment, the server of the first network platform can perform hash operation on the violation credit record data to obtain a hash value, perform encryption on the hash value according to a private key issued by the blockchain network to obtain verification information, and then transmit the verification information, the violation credit record data of the user, and a public key corresponding to the private key to the second network platform.

The server of the second network platform decrypts the verification information by using the public key to obtain the hash value calculated by the first network platform, and calculates the hash value of the violation credit record data of the user. If the hash values are consistent, it indicates that the violation credit record data of the user is not tampered with in the transmission process.

In an embodiment, each node in the blockchain network stores one or a plurality of same blockchains. The blockchain includes a plurality of blocks. Referring to FIG. 1B, the blockchain is formed by a plurality of blocks. A genesis block includes a block header and a block body. The block header stores an input information feature value, a version number, a timestamp, and a difficulty value. The block body stores input information. A next block of the genesis block uses the genesis block as a parent block, and the next block also includes a block header and a block body. The block header stores a feature value of input information of the current block, the feature value in the block header of the parent block, a version number, a timestamp, and a difficulty value, and the rest is deduced by analogy, so that block stored in each block in the blockchain is associated with block stored in the parent block, ensuring the security of the input information in the blocks.

When blocks are generated in the blockchain, referring to FIG. 1C, when the server of the second network platform receives the input information, the input information is verified according to the verification information. After the verification is completed, the input information is stored in a local internal memory pool, and a hash tree used for recording the input information is updated. Next, the timestamp is updated to the time when the input information is received, different random numbers are tried, and feature value calculation is performed a plurality of times, so that the calculated feature value may satisfy the following formula:

SHA256(SHA256(version+prev_hash+merkle_root+ntime+nbits+x))<TARGET

SHA256 is a feature value algorithm used for calculating the feature value; version (version number) is version information of a related block protocol in the blockchain; prev_hash is the feature value in the block header of the parent block of the current block; merkle_root is the feature value of the input information; ntime is an update time updating the timestamp; nbits is current difficulty, which is a fixed value within a time period and redetermined after exceeding the fixed time period; x is a random number; and TARGET is a feature value threshold, and the feature value threshold can be determined according to nbits.

In this way, when a random number satisfying the above formula is obtained through calculation, information may be correspondingly stored, and a block header and a block body are generated, to obtain a current block.

106: After the blockchain network reaches a consensus on the violation credit record data of the user, storing the violation credit record data of the user into a blockchain corresponding to the user.

In an embodiment, nodes in the blockchain may reach a consensus on the violation credit record data of the user based on a consensus algorithm of the blockchain network. Specifically, when blockchain types are different, consensus algorithms used by the nodes may be different. For example, for the consortium blockchain, the nodes may use a Practical Byzantine Fault Tolerance (PBFT) consensus algorithm; for the private blockchain, the nodes may use a Raft consensus algorithm; and for the public blockchain, the nodes may use a proof of word (PoW) consensus algorithm.

For ease of understanding, a description is made below by using an example in which consistency verification is performed based on the PBFT algorithm.

In this example, the blockchain network has 3f+1 nodes, where f is a positive integer, and each node in the network maintain a blockchain used for recording user violation credit metric data. The PBFT algorithm actually includes protocols of three stages, and the three stages are respectively prepreparation, preparation, and node confirmation, where the prepreparation and preparation stages are used for ensuring that all normal nodes execute all valid user requests according to a same sequence.

The foregoing 3f+1 nodes may be divided into one primary node and 3f backup nodes. The server of the first network platform generates a request message according to a violation credit metric parameter, and transmits the request message to the primary node for requesting to record the violation credit metric parameter in the blockchain. The primary node receives the request message and multicasts the request message to the blockchain network. The primary node then enters the prepreparation stage and generates a complex message <m>, and multicasts the complex message in the blockchain network. The backup node receives the complex message and enters the preparation stage after the complex message is successfully verified to generate a preparation message, and multicasts the preparation message. At the same time, the node stores the prepreparation message and the preparation message, and the node stores the preparation message after receiving the preparation message and the preparation message is successfully verified. When a node is prepared (Prepred (m, v, n, i)), namely, for the request m, if a node i stores the request message, the prepreparation message and 2f+1 preparation messages, the node i is prepared for m, the node generates a confirmation message and multicasts the confirmation message, and enters the confirmation stage. After the confirmation message is received and is successfully verified, the node stores the confirmation message. If one node local confirmation (Committed-local (m, v, n, i)) is established, and all requests whose serial numbers are less than n are processed, the node performs operations in the request m, and singlecasts a result to the server of the first network platform. When the server of the first network platform receives f+1 same results from different replicate nodes, since the PBFT algorithm permits at most f invalid nodes, at least one of the f+1 nodes is valid. Therefore, the result may be ensured to be valid, and all nodes in the blockchain network can write the violation credit record data of the user into the blockchain in a manner of adding a new block.

The blockchain adopts a one-way hash algorithm, each newly-generated block advances according to a time linear sequence, and irreversibility and irrevocability of time may cause any behavior attempting to invade and tamper with data information in the blockchain to be easy to trace, so that the behavior may be excluded by other nodes, and faking costs are extremely high, thereby preventing information from being tampered with.

As can be learned from the above, in this embodiment of the disclosure, the speech information published by the user on the first network platform in the blockchain network may be obtained; violation recognition is performed on the speech information to obtain a violation recognition result; in a case that the violation recognition result meets a preset violation condition, violation credit record data of the user is generated according to the violation recognition result, platform identifier information of the first network platform, and user identifier information of the user; the violation credit record data of the user is broadcast to a second network platform in the blockchain network; and after the blockchain network reaches a consensus on the violation credit record data of the user, the violation credit record data of the user is stored into a blockchain corresponding to the user. By storing the violation credit record data of the user into the blockchain, violation credit data of the user can be shared to all network platforms in the blockchain. Therefore, speech information communication behavior of the user on all the network platforms is effectively supervised.

In an embodiment, referring to FIG. 2B, a description is made by using a process of obtaining violation credit record data from a blockchain as an example. This process is performed by a speech information communication management apparatus, and the speech information communication management apparatus specifically may be integrated in the server of the first network platform. A procedure of the process is as follows:

201: Receiving a user violation credit obtaining request (or referred to as user credit obtaining request) transmitted by a terminal, the user violation credit obtaining request carrying a user identifier.

A user violation credit obtaining request may be transmitted to the server of the first network platform based on an operation of the user on a terminal interface, and the following scenario specifically may be included:

For example, when the user starts speech live streaming on the terminal interface and the terminal detects a click operation of the user on a live streaming control on the terminal interface, the user violation credit obtaining request is transmitted to the server of the first network platform.

For example, when the user views a user violation credit on the terminal interface and the terminal detects a click operation of the user on a violation credit viewing control on the terminal interface, the user violation credit obtaining request is transmitted to the server of the first network platform.

202: Determining the blockchain corresponding to the user according to the user identifier.

For ease of management of the blockchain, the violation credit record data of the user may be stored into a corresponding blockchain according to the user identifier information of the user.

The violation credit record data in the blockchain is stored in the form of a key-value pair, hash operation may be performed according to the user identifier information to obtain a hash value, and hash operation may be performed on a key element in block data to obtain a hash value. If the hash values obtained through two operation processes are consistent, the blockchain is the blockchain corresponding to the user.

203: Obtaining a block in the blockchain, and determining the violation credit record data of the user from the block.

In an embodiment, in a case that the violation credit metric information is represented as a violation credit parameter change value, all blocks in the blockchain are obtained, and all violation credit metric information of the user is obtained from all the blocks.

In another embodiment, in a case that the violation credit metric information is represented as a violation credit parameter, a current block in the blockchain is obtained, and the violation credit record data of the user is determined from the current block.

The current block refers to a latest generated block in the blockchain.

204: Returning the violation credit record data of the user to the terminal.

In an embodiment, the terminal may obtain the violation credit metric information of the user according to the violation credit record data of the user, and in a case that the violation credit metric information is represented as a violation credit parameter, the terminal directly obtains the violation credit parameter of the user at a current moment from the violation credit record data of the user.

In a case that the violation credit metric information is represented as a violation credit parameter change value, the violation credit parameter of the user at the current moment is calculated according to all violation credit parameter change values of the user.

Before the user starts live streaming, the terminal compares the obtained violation credit parameter with a preset violation credit threshold, and in a case that the violation credit parameter is greater than the preset violation credit threshold, the user is permitted to perform live streaming. Specifically, the user is permitted to use a network address interface (live streaming room) to publish speech information to other users.

In a case that the violation credit parameter is less than or equal to the preset violation credit threshold, the user is forbidden from live streaming. Specifically, the user is forbidden to use the network address interface (live streaming room) to publish speech information to other users, and prompt information is displayed on a page of the live streaming room, for example, “It is detected that your account has violation behavior, and you are forbidden from live streaming to Jan. 7, 2022” may be displayed.

In a case that the user views the violation credit parameter, the terminal displays the obtained violation credit parameter on the terminal interface, and may further display all violation recognition results of the user and corresponding violation credit metric information.

As can be learned from the above, in this embodiment of the disclosure, by storing the violation credit record data of the user into the blockchain, violation credit data of the user can be shared to all network platforms in the blockchain. Therefore, speech information communication behavior of the user on all the network platforms is effectively supervised.

As shown in FIG. 2C, in a speech information communication management method, violation credit record data in a blockchain may be further modified according to behavior of a user or violation credit record data in the blockchain, and a specific procedure may be as follows:

301: Obtaining a violation credit modification request (or referred to as credit modification request) from a terminal, the violation credit modification request carrying user identifier information of the user and violation credit record data to be modified.

In a case that the user doubts the queried violation credit record data, a violation credit modification request may be transmitted to the first network platform according to an operation of the user on the terminal interface, and after the request is successfully audited by the first network platform, target violation credit record information (or referred to as target credit record information) may be generated according to an auditing result.

An auditing standard is preset by a developer, and to ensure that data modification can be accepted by all nodes in the blockchain network, the auditing standard can be uploaded to the blockchain.

In an embodiment, situations that the user end can apply for violation credit modification are as follows:

(1) violation speech is published in a case that the user account is in an abnormal login state; (2) in a case that a voiceprint feature of the user publishing the violation speech is inconsistent with other voiceprint features of the user; and (3) in a case that the user performs behavior to restore the violation credit according to a preset violation credit rule, for example, in a case that the anchor is forbidden from live streaming, review, bullet comment, forward, favorite, and consumption behavior performed by the anchor as audience on the first network platform.

302: Obtaining target information of the user from the blockchain corresponding to the user according to the user identifier information and the violation credit record data to be modified.

In an embodiment, the target information includes current account state information; and the obtaining target information of the user from the blockchain corresponding to the user according to the user identifier information and the violation credit record data to be modified specifically may include the following operations:

determining the blockchain corresponding to the user according to the user identifier information; and

obtaining a target block in the blockchain according to the violation credit record data to be modified, and obtaining the current account state information from the target block.

The current account state information refers to information such as a login position or a login time of the user account when violation is recognized.

In an embodiment, the target information includes voiceprint feature information, and the obtaining target information of the user from the blockchain corresponding to the user according to the user identifier information and the violation credit record data to be modified specifically may include the following operations:

determining the blockchain corresponding to the user according to the user identifier information; and

obtaining a target block in the blockchain according to the violation credit record data to be modified, and obtaining the voiceprint feature information from the target block.

In an embodiment, the target information includes a user behavior data record, and obtaining user behavior data of the user according to the user identifier information specifically may include the following operations:

determining the blockchain corresponding to the user according to the user identifier information; and

obtaining a target block in the blockchain according to the violation credit record data to be modified, and obtaining the user behavior violation credit record from the target block.

After the anchor is forbidden from live streaming, the server performs recognition on obtained behavior data of the anchor (as audience), and in a case that score increasing behavior is recognized, a behavior record of the user is generated and uploaded into the blockchain according to the user identifier information of the anchor, an identifier of the first network platform, and a violation credit increment corresponding to the score increasing behavior.

303: In a case that the target information meets a preset parameter modification condition, obtaining violation credit metric information according to the met parameter modification condition.

In an embodiment, in a case that the target information is the current account state information, the server may obtain common login position information of the user according to the user identifier information; and

in a case that the common login position information is inconsistent with a login position in the current account state information, determine that the target information meets the preset parameter modification condition.

In an embodiment, in a case that the target information is voiceprint feature information, the server may obtain locally stored historical speech information of the user according to the user identifier information;

perform voiceprint feature extraction on the historical speech information to obtain historical voiceprint feature information of the user;

compare the historical voiceprint feature information with the voiceprint feature information; and

in a case that the voiceprint feature information does not match the historical voiceprint feature information, determine that the target information meets the preset parameter modification condition.

In an embodiment, in a case that the target information is a user behavior violation credit record, a violation credit parameter of the user at the current moment is calculated according to a violation credit parameter change value caused by user behavior and the violation credit parameter when the user is forbidden from live streaming, and in a case that the violation credit parameter at the current moment is greater than a preset violation credit threshold, it is considered that the target information meets the preset parameter modification condition.

304: Generating target violation credit record data (or referred to as target credit record data) according to the violation credit record data to be modified, the user identifier information, the target information, and the platform identifier information of the first network platform.

In an embodiment, the user identifier information and the violation credit record data to be modified may be used as key elements, and the target information and the platform identifier information of the first network platform are used as value elements, to generate key-value pairs.

305: Broadcasting the target violation credit record data to the second network platform in the blockchain network, and after the blockchain network reaches a consensus based on the target violation credit record data, storing the target violation credit record data into the blockchain corresponding to the user.

For processes of broadcasting and reaching a consensus, reference may be made to the foregoing embodiments, and details are not described herein again.

As can be learned from the above, in this embodiment of the disclosure, the violation credit modification request of the user may be audited according to the preset modification condition and the violation credit record data in the blockchain, and in a case of determining that the violation credit modification request meets the preset modification condition, data in the blockchain may be modified to restore the violation credit of the user.

It is to be understood that, although operations of the flowcharts in FIG. 2A, FIG. 2B, and FIG. 2C are displayed sequentially according to arrows, the operations are not necessarily performed according to an order indicated by the arrows. Unless otherwise explicitly specified in the disclosure, execution of the operations is not strictly limited, and the operations may be performed in other sequences. In addition, at least some operations in FIG. 2A, FIG. 2B, and FIG. 2C may include a plurality of operations or a plurality of stages. The operations or the stages are not necessarily performed at the same moment, but may be performed at different moments. The operations or the stages are not necessarily performed in sequence, but may be performed in turn or alternately with another operation or at least some of operations or stages of the another operation.

To better implement the foregoing methods, correspondingly, the embodiments of the disclosure further provide a speech information communication management apparatus.

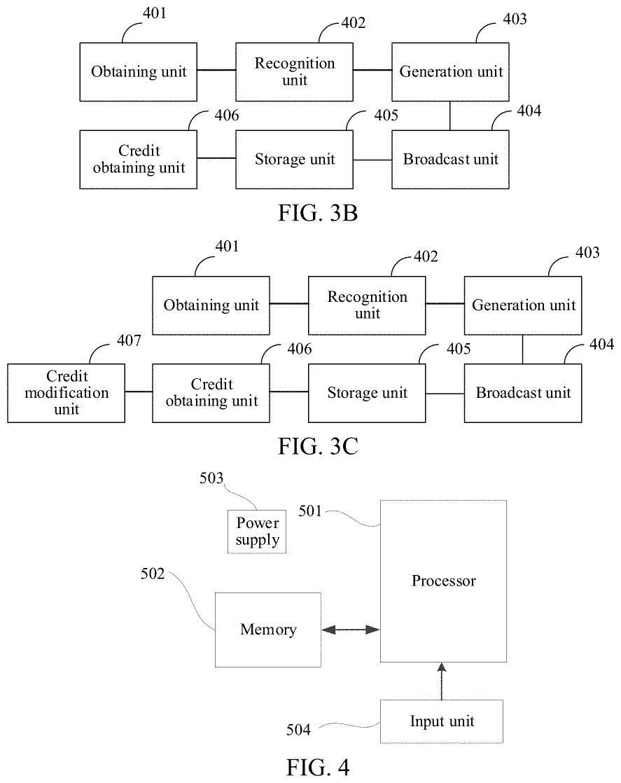

For example, as shown in FIG. 3A, the speech information communication management apparatus may include an obtaining unit 401, a recognition unit 402, a generation unit 403, a broadcast unit 404, and a storage unit 405.

(1) The obtaining unit 401 is configured to obtain speech information published by a user on a first network platform in a blockchain network.

(2) The recognition unit 402 is configured to perform violation recognition on the speech information to obtain a violation recognition result.

In an embodiment, the recognition unit 402 specifically may include a speech recognition subunit and a violation recognition subunit, where

the speech recognition subunit is configured to perform recognition on the speech information to obtain text information corresponding to the speech information; and

the violation recognition subunit is configured to perform content matching on the text information according to a preset violation information set, to obtain a matching result; and

determine the violation recognition result of the speech information according to the matching result.

In an embodiment, the speech recognition subunit specifically may be configured to:

divide the speech information to obtain an audio frame sequence corresponding to the speech information;

perform feature extraction on audio frames in the audio frame sequence, to obtain audio feature information corresponding to the speech information;

obtain phonemes corresponding to the audio feature information according to a preset acoustic model;

perform comparison and matching on the phonemes and a preset dictionary according to a preset language model, to obtain text words corresponding to the phonemes; and

extract semantic association information among the text words, and combine the text words according to the association information to obtain the text information.

(3) The generation unit 403 is configured to: in a case that the violation recognition result meets a preset violation condition, generate violation credit record data of the user according to the violation recognition result, platform identifier information of the first network platform, and user identifier information of the user.

In an embodiment, the generation unit 403 specifically may include a violation record subunit, a violation credit calculation subunit, and a generation subunit, where

the violation recording subunit is configured to: in a case that the violation recognition result meets the preset violation condition, generate a violation record according to a time, the platform identifier information of the first network platform, and the violation recognition result;

the violation credit calculation subunit is configured to obtain violation credit metric information of the user according to the violation recognition result; and

the generation subunit is configured to generate the violation credit record data of the user according to the violation record, the violation credit metric information, and the user identifier information.

In an embodiment, the generation subunit specifically may be configured to:

combine the violation credit metric information with the violation record to obtain first combination information;

combine the user identifier information with the registration identity information to obtain second combination information; and generate an association information pair according to the first combination information and the second combination information to obtain the violation credit record data of the user.

In an embodiment, the generation unit 403 may be further configured to obtain registration identity information of the user in the first network platform according to the user identifier information; and correspondingly, the generation subunit specifically may be further configured to combine the violation credit metric information with the violation record to obtain first combination information; combine the user identifier information with the registration identity information to obtain second combination information; and generate an association information pair according to the first combination information and the second combination information to obtain the violation credit record data of the user.

In an embodiment, the generation unit may be further configured to: in a case that the violation recognition result meets the preset violation condition, generate the violation credit record data of the user according to the violation recognition result, the platform identifier information of the first network platform, the user identifier information, and the voiceprint feature information.

In an embodiment, the generation unit may be further configured to: in a case that the violation recognition result meets the preset violation condition, generate the violation credit record data of the user according to the violation recognition result, the platform identifier information of the first network platform, the user identifier information, and the current account state information.

(4) The broadcast unit 404 is configured to broadcast the violation credit record data of the user to a second network platform in the blockchain network.

In an embodiment, the broadcast unit 404 may be further configured to:

generate verification information according to the violation credit record data of the user; and

in a process of broadcasting the violation credit record data of the user to the second network platform in the blockchain network, broadcast the verification information to the second network platform in the blockchain network.

(5) The storage unit 405 is configured to: after the blockchain network reaches a consensus on the violation credit record data of the user, store the violation credit record data of the user into a blockchain corresponding to the user.

In an embodiment, referring to FIG. 3B, the speech information communication management apparatus may further include a violation credit obtaining unit 406 configured to receive a user violation credit obtaining request transmitted by a terminal, the user violation credit obtaining request carrying a user identifier; determine the blockchain corresponding to the user according to the user identifier; obtain a block in the blockchain, and determine the violation credit record data of the user from the block; and return the violation credit record data of the user to the terminal.

In an embodiment, referring to FIG. 3C, the speech information communication management apparatus may further include a violation credit modification unit 407 configured to obtain a violation credit modification request from a terminal, the violation credit modification request carrying the user identifier information of the user; obtain target information of the user from the blockchain corresponding to the user according to the user identifier information and the violation credit record data to be modified; in a case that the target information meets a preset parameter modification condition, obtain violation credit metric information according to the met parameter modification condition; generate target violation credit record data according to the violation credit metric information, the user identifier information, the target information, and the platform identifier information of the first network platform; broadcast the target violation credit record data to the second network platform in the blockchain network; and after the blockchain network reaches a consensus based on the target violation credit record data, store the target violation credit record data into the blockchain corresponding to the user.

During specific implementation, the foregoing units (or code) may be implemented as independent entities, or may be randomly combined, or may be implemented as the same entity or several entities. For specific implementation of the foregoing units, refer to the foregoing method embodiments. Details are not described herein again.

As can be learned from the above, in the embodiments of the disclosure, to-be-managed information related to false information is stored into the blockchain, so that the to-be-managed information may be prevented from being tampered with based on a blockchain consensus algorithm, thereby ensuring the authenticity, credibility, and security of the information. In addition, the blockchain can broadcast the false information-based to-be-managed information more directly and widely, to govern false information more effectively.

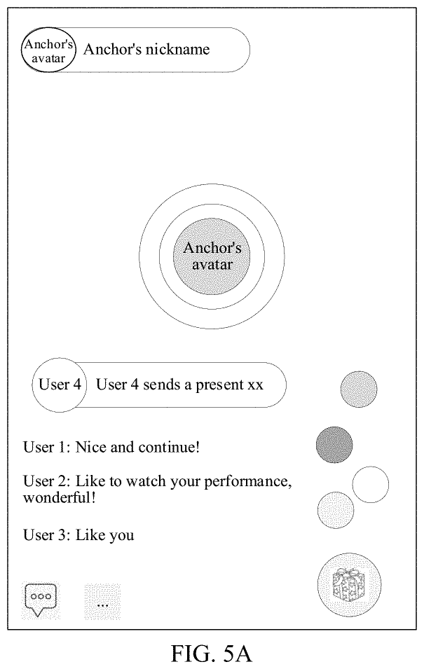

In addition, the embodiments of the disclosure further provide a speech information communication device. The speech information communication device may be used as a node in the blockchain, and in this case, the speech information communication device may be integrated in a first node of the blockchain, where the first node may be any node in the blockchain. In addition, the speech information communication device may alternatively be a terminal device. FIG. 4 is a schematic structural diagram of a computer device according to an embodiment of the disclosure. Specifically:

in this embodiment, the speech information communication device may include components such as a processor 501 with one or more processing cores, a memory 502 with one or more computer-readable storage media, a power supply 503, and an input unit 504. A person skilled in the art may understand that the structure of the device shown in FIG. 4 does not constitute a limitation to the speech information communication device, and the speech information communication device may include more components or fewer components than those shown in the figure, or some components may be combined, or a different component deployment may be used.

The processor 501 is the control center of the speech information communication device, and is connected to various parts of the speech information communication device by using various interfaces and lines. By running or executing software programs and/or modules stored in the memory 502, and invoking data stored in the memory 502, the processor performs various functions and data processing of the speech information communication device, thereby performing overall monitoring on the speech information communication device. The processor 501 may include one or more processing cores. Preferably, the processor 501 may integrate an application processor and a modem processor. The application processor mainly processes an operating system, a user interface, an application program, and the like. The modem processor mainly processes wireless communication. It may be understood that, the modem processor may alternatively not be integrated into the processor 501.

The memory 502 may be configured to store a software program and a module, and the processor 501 runs the software programs and the modules that are stored in the memory 502, to implement various functional applications and data processing. The memory 502 may mainly include a program storage area and a data storage area. The program storage area may store an operating system, an application program required by at least one function (for example, a sound playback function and an image playback function), or the like. The data storage area may store data created according to use of the computer device. In addition, the memory 502 may include a high-speed random access memory, and may further include a non-volatile memory, such as at least one magnetic disk storage device, a flash memory, or another volatile solid-state storage device. Correspondingly, the memory 502 may further include a memory controller, to allow the processor 501 to access the memory 502.

The speech information communication device further includes the power supply 503 for supplying power to the components. Exemplarily, the power supply 503 may be logically connected to the processor 501 by using a power management system, thereby implementing functions such as charging, discharging, and power consumption management by using the power management system. The power supply 503 may further include one or more of a direct current or alternating current power supply, a re-charging system, a power failure detection circuit, a power supply converter or inverter, a power supply state indicator, and any other component.

The speech information communication device may further include the input unit 504. The input unit 504 may be configured to receive inputted numeric or character information and generate touch screen, keyboard, mouse, joystick, optical, or trackball signal input related to user settings and function control.

Although not shown in the figure, the speech information communication device may further include a display unit. Details are not described herein again. Specifically, in this embodiment, the processor 501 in the computer device may load executable files corresponding to processes of one or more application programs to the memory 502 according to the following instructions, and the processor 501 runs the application program stored in the memory 502, to implement various functions as follows:

obtaining speech information published by a user on a first network platform in a blockchain network;

performing recognition on the speech information by using a preset speech recognition algorithm to obtain text information corresponding to the speech information;

performing violation recognition on the text information according to a preset violation information set, to obtain a violation recognition result;

in a case that the violation recognition result meets a preset violation condition, generating violation credit record data of the user according to the violation recognition result, platform identifier information of the first network platform, and user identifier information of the user;

broadcasting the violation credit record data of the user to a second network platform in the blockchain network; and

after the blockchain network reaches a consensus on the violation credit record data of the user, storing the violation credit record data of the user into a blockchain corresponding to the user; or

receiving a user violation credit obtaining request transmitted by a terminal, the user violation credit obtaining request carrying a user identifier; determining the blockchain corresponding to the user according to the user identifier; obtaining a block in the blockchain, and determining the violation credit record data of the user from the block; and returning the violation credit record data of the user to the terminal; or

obtaining a violation credit modification request from a terminal, the violation credit modification request carrying the user identifier information of the user;

obtaining target information of the user from the blockchain corresponding to the user according to the user identifier information and the violation credit record data to be modified;

in a case that the target information meets a preset parameter modification condition, obtaining violation credit metric information according to the met parameter modification condition;

generating target violation credit record data according to the violation credit metric information, the user identifier information, the target information, and the platform identifier information of the first network platform;

broadcasting the target violation credit record data to the second network platform in the blockchain network; and

after the blockchain network reaches a consensus based on the target violation credit record data, storing the target violation credit record data into the blockchain corresponding to the user.

For specific implementations of the above operations, refer to the foregoing embodiments. Details are not described herein again.

As can be learned from the above, in the embodiments of the disclosure, to-be-managed information related to false information is stored into the blockchain, so that the to-be-managed information may be prevented from being tampered with based on a blockchain consensus algorithm, thereby ensuring the authenticity, credibility, and security of the information. In addition, the blockchain can broadcast the false information-based to-be-managed information more directly and widely, to govern false information more effectively.

A person of ordinary skill in the art may understand that, all or some steps/operations of the methods in the foregoing embodiments may be implemented by using instructions, or implemented through instructions controlling relevant hardware, and the instructions may be stored in a computer-readable storage medium and loaded and executed by a processor.

Accordingly, the embodiments of the disclosure further provide a computer-readable storage medium, storing a plurality of instructions, the instructions being capable of being loaded by a processor, to perform operations in any speech information communication management method according to the embodiments of the disclosure. For example, the instructions may perform the following operations:

in a case of being applicable to a first node, the first node being any node in a blockchain, obtaining false information-based to-be-managed information;

generating verification information according to the to-be-managed information, the verification information including the to-be-managed information and signature information of the first node; and

storing the to-be-managed information into the blockchain based on the verification information, and causing a second node in the blockchain to reach a consensus based on the to-be-managed information and a consensus algorithm of the blockchain, where the second node is a node other than the first node in the blockchain;

in a case of being applicable to a second node, the second node is a node other than the first node in the blockchain, obtaining an information obtaining request transmitted by a terminal;

determining a blockchain in which target to-be-managed information is located from the blockchain according to attributes of information required by the information obtaining request;

obtaining a block in the blockchain based on the information obtaining request, the block including the false information-based to-be-managed information; and

generating push information according to the to-be-managed information, and returning the push information to the terminal.

For specific implementations of the above operations, refer to the foregoing embodiments. Details are not described herein again.

The computer-readable storage medium may include: a read-only memory (ROM), a random access memory (RAM), a magnetic disk, an optical disc, or the like.

Because the instructions stored in the computer-readable storage medium may perform the operations of any speech information communication management method in the embodiments of the disclosure, the instructions can implement beneficial effects that may be implemented by any speech information communication management method in the embodiments of the disclosure. For details, refer to the foregoing embodiments. Details are not described herein again.

The speech information communication management method and apparatus, and the storage medium provided in the embodiments of the disclosure are described in detail above. The principles and implementations of the disclosure are described through specific examples in this specification, and the descriptions of the embodiments are only intended to help understand the methods and core ideas of the disclosure. Meanwhile, a person skilled in the art may make modifications to the specific implementations and application scopes according to the ideas of the disclosure. In conclusion, the content of this specification is not to be construed as a limitation to the disclosure.

What is claimed is:

1. A speech information communication management method, performed by a computer device, comprising:
obtaining speech information published by a user on a first network platform in a blockchain network;
performing violation recognition on the speech information to obtain a violation recognition result;
in a case that the violation recognition result meets a preset violation condition, generating violation credit record data of the user according to the violation recognition result, platform identifier information of the first network platform, and user identifier information of the user;
broadcasting the violation credit record data of the user to a second network platform in the blockchain network; and
after the blockchain network reaches a consensus on the violation credit record data of the user, storing the violation credit record data of the user into a blockchain corresponding to the user.

2. The speech information communication management method according to claim 1, wherein the in a case that the violation recognition result meets a preset violation condition, generating violation credit record data of the user according to the violation recognition result, platform identifier information of the first network platform, and user identifier information of the user comprises:
in a case that the violation recognition result meets the preset violation condition, generating a violation record according to a time, the platform identifier information of the first network platform, and the violation recognition result;
obtaining violation credit metric information of the user according to the violation recognition result; and
generating the violation credit record data of the user according to the violation record, the violation credit metric information, and the user identifier information.

3. The speech information communication management method according to claim 2, wherein the generating the violation credit record data of the user according to the violation record, the violation credit metric information, and the user identifier information comprises:
combining the violation credit metric information with the violation record to obtain first combination information;
combining the user identifier information with registration identity information to obtain second combination information; and generating an association information pair according to the first combination information and the second combination information to obtain the violation credit record data of the user.

4. The speech information communication management method according to claim 2, wherein the generating the violation credit record data of the user according to the violation record, the violation credit metric information, and the user identifier information comprises:
obtaining registration identity information of the user in the first network platform according to the user identifier information;
combining the violation credit metric information with the violation record to obtain first combination information;
combining the user identifier information with the registration identity information to obtain second combination information; and
generating an association information pair according to the first combination information and the second combination information to obtain the violation credit record data of the user.

5. The speech information communication management method according to claim 1, wherein the method further comprises:
performing voiceprint feature recognition on the speech information to obtain voiceprint feature information of the user; and
in a case that the violation recognition result meets the preset violation condition, generating the violation credit record data of the user according to the violation recognition result, the platform identifier information of the first network platform, the user identifier information, and the voiceprint feature information.

6. The speech information communication management method according to claim 1, wherein the method further comprises:
obtaining current account state information of the user; and
in a case that the violation recognition result meets the preset violation condition, generating the violation credit record data of the user according to the violation recognition result, the platform identifier information of the first network platform, the user identifier information, and the current account state information.

7. The speech information communication management method according to claim 2, wherein after the obtaining violation credit metric information of the user according to the violation recognition result, the method further comprises:
performing speech information publish permission recognition on the user according to a preset violation credit threshold and the violation credit metric information, to obtain a permission recognition result; and
stopping, in a case that the permission recognition result represents that the user does not have a speech information publish permission, receiving the speech information transmitted by the user.

8. The speech information communication management method according to claim 2, wherein after the obtaining violation credit metric information of the user according to the violation recognition result, the method further comprises:
generating a violation credit alarm message according to the violation record and the violation credit metric information; and
returning the violation credit alarm message to a terminal.

9. The speech information communication management method according to claim 1, wherein the method further comprises:
generating verification information according to the violation credit record data of the user; and
in a process of broadcasting the violation credit record data of the user to the second network platform in the blockchain network, broadcasting the verification information to the second network platform in the blockchain network.

10. The speech information communication management method according to claim 1, wherein the performing comprises:
performing recognition on the speech information to obtain text information corresponding to the speech information;
performing content matching on the text information according to a preset violation information set, to obtain a matching result; and
determining the violation recognition result of the speech information according to the matching result.

11. The speech information communication management method according to claim 10, wherein the performing recognition on the speech information to obtain text information corresponding to the speech information comprises:
dividing the speech information to obtain an audio frame sequence corresponding to the speech information;
performing feature extraction on audio frames in the audio frame sequence, to obtain audio feature information corresponding to the speech information;
obtaining phonemes corresponding to the audio feature information according to a preset acoustic model;
performing comparison and matching on the phonemes and a preset dictionary according to a preset language model, to obtain text words corresponding to the phonemes; and
extracting semantic association information among the text words, and combining the text words according to the association information to obtain the text information.

12. The speech information communication management method according to claim 1, wherein the method further comprises:
receiving a user violation credit obtaining request transmitted by a terminal, the user violation credit obtaining request carrying a user identifier;
determining the blockchain corresponding to the user according to the user identifier;
obtaining a block in the blockchain, and determining the violation credit record data of the user from the block; and
returning the violation credit record data of the user to the terminal.

13. The speech information communication management method according to claim 1, wherein the method further comprises:
obtaining a violation credit modification request from a terminal, the violation credit modification request carrying the user identifier information of the user;
obtaining target information of the user from the blockchain corresponding to the user according to the user identifier information and the violation credit record data to be modified;
in a case that the target information meets a preset parameter modification condition, obtaining violation credit metric information according to the met parameter modification condition;
generating target violation credit record data according to the violation credit metric information, the user identifier information, the target information, and the platform identifier information of the first network platform;
broadcasting the target violation credit record data to the second network platform in the blockchain network; and
after the blockchain network reaches a consensus based on the target violation credit record data, storing the target violation credit record data into the blockchain corresponding to the user.

14. A speech information communication management apparatus, comprising:
at least one memory configured to store program code; and
at least one processor configured to read the program code and operate as instructed by the program code, the program code comprising:
obtaining code configured to cause the at least one processor to obtain speech information published by a user on a first network platform in a blockchain network;
recognition code configured to cause the at least one processor to perform violation recognition on the speech information to obtain a violation recognition result;
generation code configured to cause the at least one processor to, in a case that the violation recognition result meets a preset violation condition, generate violation credit record data of the user according to the violation recognition result, platform identifier information of the first network platform, and user identifier information of the user;
broadcast code configured to cause the at least one processor to broadcast the violation credit record data of the user to a second network platform in the blockchain network; and
storage code configured to cause the at least one processor to, after the blockchain network reaches a consensus on the violation credit record data of the user, store the violation credit record data of the user into a blockchain corresponding to the user.

15. The speech information communication management apparatus according to claim 14, wherein the generation code comprises:
violation recording code configured to cause the at least one processor to, in a case that the violation recognition result meets the preset violation condition, generate a violation record according to a time, the platform identifier information of the first network platform, and the violation recognition result;
violation credit calculation code configured to cause that least one processor to obtain violation credit metric information of the user according to the violation recognition result; and
second generation code configured to cause the at least one processor to generate the violation credit record data of the user according to the violation record, the violation credit metric information, and the user identifier information.

16. The speech information communication management apparatus according to claim 15, wherein the second generation code is configured to cause the at least one processor to:
combine the violation credit metric information with the violation record to obtain first combination information;
combine the user identifier information with registration identity information to obtain second combination information; and generate an association information pair according to the first combination information and the second combination information to obtain the violation credit record data of the user.

17. The speech information communication management apparatus according to claim 15, wherein the generation code is further configured to cause the at least one processor to obtain registration identity information of the user in the first network platform according to the user identifier information; and
the second generation code is further configured to cause the at least one processor to combine the violation credit metric information with the violation record to obtain first combination information; combine the user identifier information with the registration identity information to obtain second combination information; and generate an association information pair according to the first combination information and the second combination information to obtain the violation credit record data of the user.

18. The speech information communication management apparatus according to claim 14, wherein the generation code is further configured to cause the at least one processor to perform voiceprint feature recognition on the speech information to obtain voiceprint feature information of the user; and
in a case that the violation recognition result meets the preset violation condition, generate the violation credit record data of the user according to the violation recognition result, the platform identifier information of the first network platform, the user identifier information, and the voiceprint feature information.

19. A non-volatile computer-readable storage medium, storing a computer program code, that when executed by at least one processor causes the at least one processor to:
obtain speech information published by a user on a first network platform in a blockchain network;
perform violation recognition on the speech information to obtain a violation recognition result;
in a case that the violation recognition result meets a preset violation condition, generate violation credit record data of the user according to the violation recognition result, platform identifier information of the first network platform, and user identifier information of the user;
broadcast the violation credit record data of the user to a second network platform in the blockchain network; and
after the blockchain network reaches a consensus on the violation credit record data of the user, store the violation credit record data of the user into a blockchain corresponding to the user.

20. The non-volatile computer-readable storage medium according to claim 19, wherein the in a case that the violation recognition result meets a preset violation condition, generate violation credit record data of the user according to the violation recognition result, platform identifier information of the first network platform, and user identifier information of the user comprises:
in a case that the violation recognition result meets the preset violation condition, generating a violation record according to a time, the platform identifier information of the first network platform, and the violation recognition result;
obtaining violation credit metric information of the user according to the violation recognition result; and
generating the violation credit record data of the user according to the violation record, the violation credit metric information, and the user identifier information.
